(19) United States
(12) Patent Application Publication
(10) Pub. No.: US 2025/0341821 A1
(43) Pub. Date: Nov. 6, 2025

(54) Connectivity-Guided Control of an Industrial System

(71) Applicant: ABB Schweiz AG, Baden (CH)

(72) Inventors: Krister Landernäs, Hallstahammar (SE); Mikael Norrlöf, Norrköping (SE)

(21) Appl. No.: 18/867,058

(22) PCT Filed: Jun. 13, 2022
(86) PCT No.: PCT/EP2022/066001

§ 371 Date: Nov. 19, 2024

(51) Int. Cl. G05B 19/418; H04B 17/318

(52) U.S. Cl. CPC G05B 19/4185; G05B 19/4184; H04B 17/318

(57) ABSTRACT

A method of controlling an industrial system which includes: a material-handling subsystem, which is operable at a variable characteristic speed, an industrial robot configured to cooperate with the material-handling subsystem, at least one sensor configured to capture at least one operating state of the industrial system, and a wireless interface configured to maintain a wireless communication link to a remote processor. The method includes operating the industrial system while communicating with the remote processor over the wireless communication link, including transmitting sensor signals from said at least one sensor and receiving control signals destined for the industrial robot; monitoring the wireless communication link's performance; and controlling the characteristic speed of the material-handling subsystem on the basis of the monitored performance.

### TECHNICAL FIELD

The present disclosure relates to the field of factory automation. It proposes methods and devices for controlling an industrial system composed of multiple cooperating subsystems, wherein the control is performed at least in part over a wireless connection.

### BACKGROUND

According to recent trends in factory automation, an increasing share of devices will be controlled and monitored over wireless links rather than wired connections. The use of wireless communication makes it easier to replace and reconfigure devices in an existing factory environment, it evidently avoids the cost of installing and maintaining cabling, and it could also be a decisive enabler for connecting densely clustered or otherwise inaccessible devices in a factory. Wireless control of mobile automation devices, such as mobile robots or automated guided vehicles (AGVs), is also advantageous in that the necessary computational capacity can be provided by a remote processor (e.g., cloud processing resource) rather than an onboard processor that could drain significant energy from the battery of the mobile automation device.

Compared with a wired connection, however, a wireless link is inherently more exposed to disturbances, including atmospheric and meteorologic conditions, radio interference, as well as the presence of absorbing or reflective objects in the vicinity of the communication path. Such factors limit the transmission capacity of the wireless link and could at worst cause it to break down. The disturbances are difficult to predict and counter when the wired link extends between moving communicating parties, especially in a changing environment like a factory. The delivered transmission capacity of a wireless link may also vary significantly with the current network load, the distance to base stations and scheduling decision in the network.

US20210094177A1 discloses a method of controlling mobile robotic devices communicating over a radio link with a cloud platform. The quality of the radio link is calculated or estimated. On this basis, the method assesses whether the radio link to the cloud platform is able to satisfy a “communication demand”, such as sufficiently low latency or low delay. If it is expected that the radio link will no longer satisfy the communication demand, the mobile robotic device can be slowed down, so as to remain in an area with good network coverage, or it can be re-routed from its originally planned path. This is hoped to reduce the likelihood of a failure.

In other words, US20210094177A1 discloses ways of avoiding poor coverage but does not address the situation where network coverage has already degraded. The applicability of these teachings is also limited to such use cases where it is acceptable for the mobile robot device to arrive at its destination with a significant delay and/or to deviate from its planned path. It would be desirable to find ways of handling the radio link quality variations without sacrificing productivity.

### SUMMARY

One objective of the present disclosure is to make available a method for enabling partially wireless control of an industrial system with multiple cooperating subsystems which is more robust to variations in the wireless link performance. The method should be more robust in this sense insofar as the likelihood of production failure is reduced and/or there is a better expectation of maintaining some degree of productivity through a temporary drop in wireless link performance. A further objective is to make available such a method that is suitable when the wireless link is used for controlling one of the subsystems (e.g., an industrial robot) from a remote processor, while a further subsystem is controlled directly. Another objective is to propose such a method suitable for use cases where the wireless link further transmits sensors signals to the remote processor.

At least some of these objectives are achieved by the invention as defined by the independent claims. The dependent claims relate to advantageous embodiments.

In a first aspect of the invention, there is provided a method of controlling an industrial system. The industrial system includes: a material-handling subsystem, which is operable at a variable characteristic speed, at least one industrial robot configured to cooperate with the material-handling subsystem, at least one sensor configured to capture at least one operating state of the industrial system, and a wireless interface configured to maintain a wireless communication link to a remote processor. According to the method, the industrial system is operated while communicating with the remote processor over the wireless communication link, including transmitting sensor signals from said at least one sensor and receiving control signals destined for the industrial robot(s). During the operation, the wireless communication link's performance is monitored, and the characteristic speed of the material-handling subsystem is controlled on the basis of the monitored performance of the communication link.

By controlling the characteristic speed of the material-handling subsystem, as the first aspect of the invention provides, the negative impact of a drop in wireless link performance can be mitigated. In particular, the characteristic speed of the material-handling subsystem can be temporarily reduced until the wireless link performance recovers. It is possible, thanks to the speed regulation, to temporarily reduce the degree of difficulty—and thus the risk of failure—of the task of controlling the industrial robot. The degree of difficulty may be quantified, for example, in terms of the maximum tolerable delay between an event captured by the sensor(s) and a corresponding reaction by the industrial robot, the number of robot movements per unit time of the robot in steady state, or the expected cost of one erroneous robot movement (e.g., number of workpieces to be discarded). The significant robustness improvement made possible by the present invention could make wireless control an attractive option for a larger set of use cases.

In some embodiments, the material-handling subsystem includes a conveyor. In some embodiments, the material-handling subsystem includes one or more mobile robots or one or more automated guided vehicles (AGVs).

In a second aspect of the invention, there is provided a processor configured to be communicatively connected to an industrial system and to perform the above method.

In a third aspect, there is provided an industrial system, which comprises, in addition to this processor, a material-handling subsystem, which is operable at a variable characteristic speed, an industrial robot configured to cooperate with the material-handling subsystem, at least one sensor configured to capture at least one operating state of the industrial system, and a wireless interface configured to maintain a wireless communication link to a remote processor.

The second and third aspects of the invention generally share the effects and advantages of the first aspect, and they can be implemented with a corresponding degree of technical variation.

The invention further relates to a computer program containing instructions for causing a computer, or in particular said processor configured to be communicatively connected to the industrial system, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

In the present disclosure, it is understood that the material-handling system may have components that move at different speeds. Speeds in this sense may include a linear speed, an angular speed, a number of work cycles per unit time, etc. Pairs or groups of the components may be moving with a mutual synchronicity, e.g., as a result of mechanical gears, electronic triggers, or complex logic circuits. A “characteristic speed” in the sense of the claims is a representative speed, from which the further speeds of at least the main components can be derived. A main component in this sense may be a conveyor with equally spaced compartments that supplies workpieces for processing by the industrial robot, indeed, because a higher supply speed will make the robot more vulnerable to glitches and delays in the control loop. The wanted effects of the invention may be achieved even if the material-handling system includes components (non-main components) that are unaffected or just indirectly affected by a change in the characteristic speed, such as a cooling fan.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order described, unless explicitly stated.

### BRIEF DESCRIPTION OF THE DRAWINGS

Aspects and embodiments are now described, by way of example, with reference to the accompanying drawings, on which:

FIG. 1 shows an industrial system with multiple subsystems including a material-handling subsystem and a remotely controlled industrial robot coopering with the material-handling subsystem;

FIG. 2 is a flowchart of a control method, according to embodiments herein; and

FIG. 3 depicts a pick-and-place robot which receives items from containers carried by automatic guided vehicles (AGVs) which constitute an upstream portion of the material-handling subsystem, wherein the robot is configured to place the items in boxes that travel on a conveyor belt acting as a downstream portion of the material-handling subsystem.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

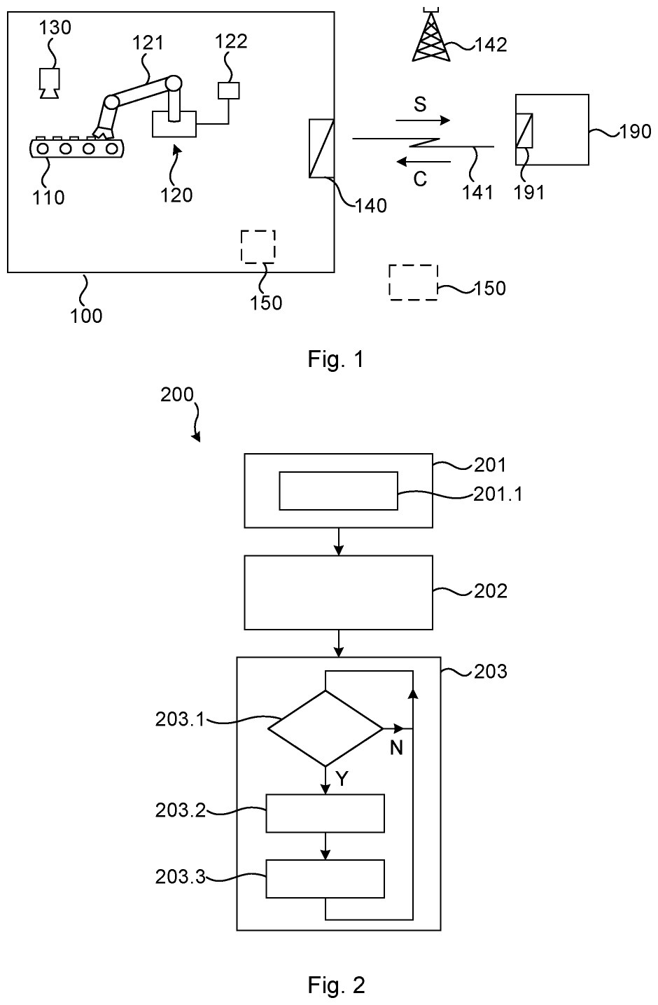

FIG. 1 shows an industrial system 100 made up of multiple subsystems, sensors 130 and a wireless interface 140. Each subsystem can be a sensor system, an actuator system or a combination of actuators and sensors. The subsystems include at least a material-handling subsystem 110 and an industrial robot 120 cooperating with the material-handling subsystem 110. In operation, the components of the material-handling subsystem 110 move at equal or different speeds. At each point in time, the speed(s) of at least the main components of the material-handling subsystem 110 can be summarized or collectively described in terms of a characteristic speed, as discussed in an earlier section of this disclosure. It is assumed, moreover, that the characteristic speed can be varied. A change in the characteristic speed may imply a concurrent change in speed of other components, and the changes may be related through a constant proportionality factor.

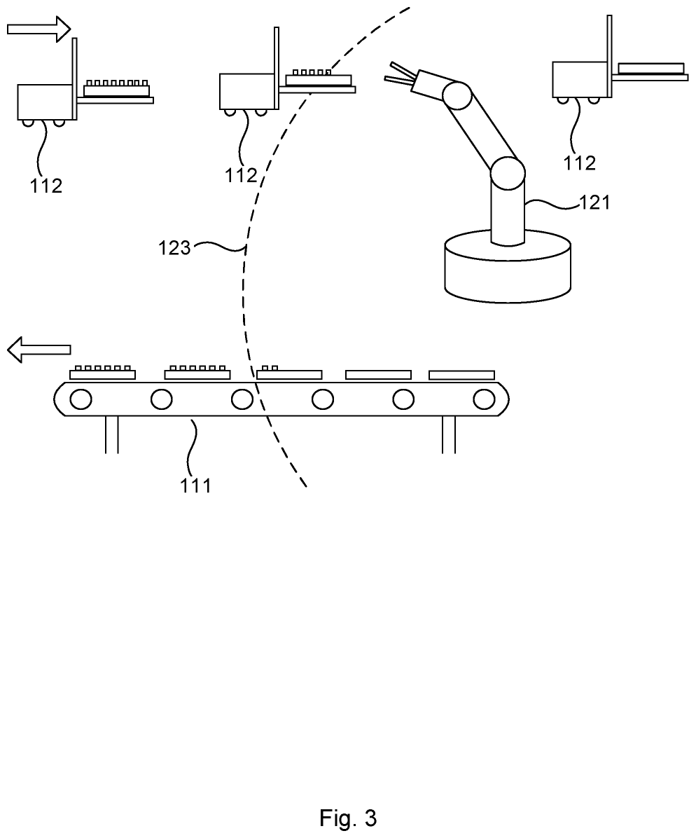

As shown in FIG. 3, the material-handling subsystem 110 can have both an upstream portion 112 and a downstream portion 111. In principle, such an upstream portion 112 is responsible for feeding workpieces into a working area 123, where they are to be processed by a robot manipulator 121 of the industrial robot 120. As used herein, a “robot manipulator” may refer to all parts of an industrial robot that is not the robot controller, such as an AGV, a stationary robot arm, a mobile robot with an arm. The processing may include picking, placing, turning, packing, inspecting, treating, cutting, painting or the like. The downstream portion 111 is responsible, in principle, for transporting processed workpieces out of the working area 123. In the example illustrated in FIG. 3, a pick-and-place robot 121 receives items from containers carried by AGVs 112 (upstream portion of the material-handling subsystem 110) and is configured to place the items into boxes that travel on a conveyor 111 (downstream portion of the material-handling subsystem 110). One possible control strategy is to send a constant setpoint number of loaded AGVs into the working area 123 per unit time, and to let each AGV dwell in the working area 123 for a predetermined period, during which the items are to be picked. Although the AGVs may have interactive functionalities, such as collision avoidance based on local sensors, the control strategy is basically open-loop. It is noted that the characteristic speed of the upstream portion of the material-handling subsystem 110 determines a minimum number of work cycles per unit time of the industrial robot 120, or otherwise there will be an overflow of incoming workpieces to be processed. Similarly, the characteristic speed of the downstream portion of the material-handling subsystem 110 determines a maximum number of work cycles per unit time of the industrial robot 120; exceeding this number could imply that processed workpieces accumulate in the working area 123 would mean for lack of sufficient capacity to transport the workpieces away.

Resuming the description of FIG. 1, the industrial robot 120 is controlled by a remote processor 190 over a wireless communication link 141 having the wireless interface 140 and a processor-side wireless interface 191 as its endpoints. It is understood that the wireless communication link 141 can be operated as a stack of communication protocols ranging from a physical layer over various intermediate layers up to an application layer. The intermediate layers may for example include a data-link layer, network layer and transport layer, like in the OSI model. The endpoints of the upper layers may be wider apart than the wireless interfaces 140, 191 themselves; for example, the application-layer endpoints may be a software process executing in the industrial robot 120 and a software process executing in the remote processor 190.

The processor 190 is “remote” in relation to the industrial robot 120 in the sense that it is not a component of the industrial robot 120 and/or it communicates with the industrial robot 120 over the wireless communication link 141 (rather than, say, over an internal bus or a local data network). Optionally, the remote processor 190 may as well be located at a significant physical distance from the industrial robot 120. The further subsystems of the industrial system 100, including the material-handling subsystem 110, may be monitored or controlled by a further processor 150, which can be included in the industrial system 100 or located externally, outside the industrial system 100. The further subsystems of the industrial system 100 can be connected to the processor 150 via a wired data network or dedicated cabling, or they can be controlled over a wireless link similar to that of the industrial robot 120. In other words, the material-handling subsystem 110 and the industrial robot 120 are controlled by two independent processors. In a typical configuration, the industrial robot 120 is controlled in view of the current operating state of the material-handling subsystem 110 (e.g., machinery settings, load carried), whereas the material-handling subsystem 110 operates autonomously. Put differently, the material-handling subsystem 110 is operated in an open-loop fashion, and the industrial robot 120 is controlled in dependence of its operating state. Because the operating state of material-handling subsystem 110 is to some extent non-deterministic, especially regarding the quantity and positions of the workpieces carried, successful control of the industrial robot 120 require fast reactivity, which in turn may need accurate information about the operating states. The sensors 130 are arranged to capture such operating states.

On the wireless link 141, sensor signals S indicative of operating states of the industrial system 100 are transferred towards the remote processor 190, and control signals C destined for the industrial robot 120 are transferred towards the wireless interface 140. The exact way in which the remote processor 190 generates the control signals C is not essential to the invention; for example, the remote processor 190 may be executing a version of the software PickMaster™ marketed by the applicant. It is understood that the remote processor 190 is configured to provide control signals C of a high-level character, whereas the robot controller 122 is configured to generate machine-level signals to actuators in the robot manipulator 121 on the basis of the control signals C and in compliance with them. The robot controller 122 may further be equipped with power electronics for generating an electric drive signal suitable for these actuators, such as a modulated alternating-current (AC) signal. If the industrial robot 120 is a mobile robot or AGV, then the robot controller 122 is usually integrated in the robot manipulator 121.

In some embodiments, the wireless interface 140 is an autonomous component of the industrial system 100, wherein a (wireless) data connection is provided from the wireless interface 140 to the industrial robot 120. In other embodiments, the wireless interface 140 is carried by or is integrated in the industrial robot 120. This is particularly useful if the industrial robot 120 is a mobile robot or AGV. The wireless interface 140 may be configured to establish a wireless link 141 directly to the processor-side wireless interface 191, or the wireless link 141 may be supported by network infrastructure 142. The network infrastructure 142 may be cellular (e.g., a 3GPP NR network, or “5G” network) or non-cellular. As is well-known to those skilled in the art, two parties communicating over a cellular network will be relied by one uplink/downlink pair each, each extending from the respective party's user equipment (UE) to a base station (BS) in the radio access network (RAN) of the cellular network, and the communicated data will be routed between the base stations through the RAN and/or through a core network. Accordingly, the wireless link 141, which for simplicity is illustrated as a single connection between the wireless interfaces 140, 191 in FIG. 1, will be composed of multiple segments that include the network infrastructure 142. Similarly, in a non-cellular network such as an IEEE 802.11 (Wi-Fi™) network, two communicating mobile stations (MSs) may be connected to a common access point (AP) but each over a respective uplink/downlink pair to the AP.

On the side of the remote processor 190, the wireless interface 191 can either be collocated with the remote processor 190. In particular, the wireless interface 191 may be a component thereof, such as a UE subscriber module and associated hardware. It is recalled that two UEs in a cellular network do not communicate directly but via the RAN. Alternatively, the wireless interface 191 could belong to network infrastructure not dedicated to the remote processor 190. The second option is applicable, for example, if the remote processor 190 is connected directly to a host computer in the core network, in which case the uplink/downlink pair between the wireless module 140 and the BS will be the only wireless segment of the data connection between the wireless module and the remote processor 190. Either way, the placement of the remote processor 190 relative to the industrial robot 120 can be chosen as the implementer desires within wide limits without significantly affecting the performance and characteristics of the wireless link 141.

In the example illustrated in FIG. 1, the material-handling subsystem 110 is illustrated as a conveyor arranged to transport workpieces. The characteristic speed of a conveyor may be taken to be the linear speed of the upper surface of the conveyor belt. If the conveyor belt is driven by an electric motor, there is normally a stable linear relationship between the angular velocity of the motor and the linear speed of the conveyor belt, as defined by a gear ratio, cylinder radius or the like. The speed of the conveyor belt can be increased or decreased by a desired percentage by accelerating or decelerating the electric motor by an equal percentage.

For comparison, the characteristic speed of the AGVs 112 shown in FIG. 3 may be taken to be the setpoint number of loaded AGVs which are to arrive in the working area 123 per unit time. AGVs could represent a more flexible solution compared to general conveyors, because with AGVs it is possible to vary the flow speed locally by controlling a single AGV. In a conveyor solution, the entire flow is affected if the speed of the conveyor is changing. In the present disclosure, the characteristic speed may be controlled by sending commands to a single AGV or a subgroup of AGVs out of the total number.

In the example of FIG. 1, the industrial robot 120 is composed of a multi-axis robot manipulator 121 and a robot controller 122 connected to this by a wired communication link (solid line). The robot manipulator 121 may carry a tool, or end-effector. The industrial robot 120 is configured to cooperate with the conveyor by picking workpieces from the conveyor when these enter the working area of the robot manipulator 121. A successful picking operation must not include mechanically damaging the workpiece due to incorrect gripping, nor dropping it, and the picking must be performed timely before the workpiece leaves the working area or fall off the far end of the conveyor. As such, timely and accurate position information is usually required in order to successfully pick the workpieces. For this purpose, a sensor 130 in the form of an imaging device is arranged to monitor the conveyor and the workpieces currently traveling on it. The imaging device may for example be a still or video camera, a three-dimensional (3D) camera, lidar, or a color-depth camera (such as RGB-D). A very simple implementation is to implement the imaging device as a line sensor or a photocell capable of revealing the presence of an object in its field of view.

Having now described the general setting of the present disclosure, a method 200 of controlling the industrial system 110 will be described with reference to FIG. 2. The method 200 can be executed by any programmable processor. In particular, it may be executed by the remote processor 190, by the further processor 150 which controls the material-handling subsystem 110, or by yet another processor.

In a first step 201 of the method 200, the industrial system 100 is operated while communicating with the remote processor 190 over the wireless communication link 141. As explained above, the wireless communication link 141 conveys sensor signals S from the sensor(s) 130 and control signals C destined for the industrial robot 120, or more particularly for a robot controller 122 thereof.

In a second step 202, the performance of the wireless communication link 141 is monitored. This monitoring 202 may be performed in parallel with step 201, i.e., for its entire duration, or overlapping in time with step 201. The monitoring 202 may be a continuous or quasi-continuous process. Alternatively, the monitoring 202 may be performed at discrete points in time in a periodic or event-triggered fashion.

The monitoring 202 of the wireless communication link 141 can proceed in several different ways. One option is to carry out a direct radio measurement on the wireless communication link 141. The radio measurement may be performed using a receiver configured to receive electromagnetic waves. The radio measurement may be directed at transmissions that form part of the operating wireless communication link 141. Alternatively, the radio measurement may be designed to capture characteristics of the radio environment in which the wireless communication link 141 is located, wherein the measurement may be directed at a reference signal or pilot signal transmitted for this purpose. Quantities to be captured or estimated by the radio measurement could for example include the following: received signal strength, signal-to-interference ratio (SIR), signal-to-noise ratio (SNR), signal-to-noise-and-interference ratio (SNIR), delay spread, MIMO transmission rank. These quantities may be indicative of the maximum data transfer capacity of the wireless link 141, or the likelihood for disturbances to occur, or both.

A second option for monitoring 202 the wireless communication link 141 is to carry out a measurement on an application layer of the wireless link 141. The measurement may include monitoring the times of dispatch and arrival of messages carrying sensor data S and control data C on the wireless link 141, or monitoring such dispatch and arrival times for dedicated test messages. This allows estimating delay, latency, jitter, other timing-related quantities as well as packet loss indicators. The application-layer measurement does not require access to a radio receiver.

A third option for monitoring 202 the wireless communication link 141 can be practiced when the wireless link 141 is supported by network infrastructure 142. According to the third option, at least one lower-layer performance indicator is obtained from the network infrastructure 142. The performance indicator may be one of the physical-layer quantities that are directly measured according to the first option (e.g., received signal strength, SIR, SNR, SNIR, delay spread, MIMO transmission rank) but could also be higher-layer indicators such as jitter, delay, packet error rate or packet loss rate. The performance indicator may be obtained by requesting it from a node in the network infrastructure 142 or by gaining access to operational parameters of the network infrastructure 142 at runtime. For example, the network infrastructure 142 may include a publish/subscribe (PubSub) service configured to expose the operational parameters. The PubSub service may be compliant with the Data Distribution Service (DDS) standard or the Open Platform Communications Unified Architecture (OPC UA) PubSub protocol, or alternatively be compliant with specifications for the Network Exposure Function (NEF) Northbound Interface of 3GPP NR if the network infrastructure 142 belongs to a cellular network. An advantage of using a PubSub arrangement is that the method 200 can be executed without accessing low-level information relating to states of the network infrastructure 142.

In a third step 203 of the method 200, the characteristic speed of the material-handling subsystem 110 is controlled on the basis of the monitored performance of the wireless link 141. In principle, the characteristic speed is to be decreased when the performance of the wireless link 141 is poor, and vice versa.

In one embodiment, the control is performed on the basis of a predefined lookup table is provided which associates different levels of wireless link performance with corresponding values of the characteristic speed. The wireless link performance may for example be expressed as on or more numerical quantities, and the values of the quantities may be related to predefined ranges or bins, each having a corresponding value of the characteristic speed.

In a second embodiment, the control is based on a predefined threshold performance. Initially, the material-handling subsystem 110 is operated 201.1 at a default value of the characteristic speed, and the monitored performance of the wireless communication link 141 is compared 203.1 with the predefined threshold performance. If the monitored performance falls below the predefined performance threshold, the material-handling subsystem 110 is operated 203.2 at a reduced value of the characteristic speed. The reduced value can be a predefined percentage lower than the default value, such as 25% or 50% lower. The characteristic speed can be restored to the default value once the monitored performance of the wireless communication link 141 raises above the performance threshold again.

In an optional substep 203.3 within said second embodiment, a finding that the monitored performance falls below the predefined performance threshold further triggers a change in the settings of the industrial robot 120. More precisely, the work pace of the industrial robot 120 is limited. The slowing down of the industrial robot 120 may be inherent if the material-handling subsystem 110 is located on the upstream side, indeed, since the industrial robot 120 will run out of workpieces to process when the characteristic speed is reduced. Even a slowing down of a downstream portion of the material-handling subsystem 110 could have a similar effect since the ability to deposit processed workpieces may become a bottleneck for the industrial robot 120. Anyhow, and especially if the industrial robot's 120 dependence on the material-handling subsystem 110 is not direct, it could make sense to include the optional step 203.3. For example, it could lead to smoother and more reliable operation.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A method of controlling an industrial system, which industrial system includes:
a material-handling subsystem, which is operable at a variable characteristic speed,
an industrial robot configured to cooperate with the material-handling subsystem,
at least one sensor configured to capture at least one operating state of the industrial system, and
a wireless interface configured to maintain a wireless communication link to a remote processor,
the method comprising:
operating the industrial system while communicating with the remote processor over the wireless communication link, including transmitting sensor signals from said at least one sensor and receiving control signals-destined for the industrial robot;
monitoring the wireless communication link's performance; and
controlling the characteristic speed of the material-handling subsystem on the basis of the monitored performance.

2. The method of claim 1, wherein:
said operation of the industrial system includes:
initially operating the material-handling subsystem at a default value of the characteristic speed,
said controlling includes:
comparing the monitored performance with a predefined threshold performance; and,
in response to the monitored performance falling below the predefined performance threshold, operating the material-handling subsystem at a reduced value of the characteristic speed.

3. The method of claim 2, wherein said controlling further includes:
in response to the monitored performance falling below the predefined performance threshold, limiting a work pace of the industrial robot.

4. The method of claim 1, wherein:
the wireless communication link is supported by network infrastructure, and
said monitoring the performance includes obtaining a lower-layer performance indicator from the network infrastructure.

5. The method of claim 1, wherein said monitoring the performance includes carrying out a radio measurement on the wireless communication link.

6. The method of claim 1, wherein said monitoring the performance includes carrying out a measurement on an application layer of the wireless communication link.

7. The method of claim 1, wherein the material-handling subsystem is arranged at least upstream of the industrial robot.

8. The method of claim 7, wherein the characteristic speed of the material-handling subsystem determines a minimum number of work cycles per unit time of the industrial robot.

9. The method of claim 1, wherein the material-handling subsystem is arranged at least downstream of the industrial robot.

10. The method of claim 9, wherein the characteristic speed of the material-handling subsystem determines a maximum number of work cycles per unit time of the industrial robot.

11. The method of claim 1, wherein the industrial robot is a pick-and-place robot configured to pick items from the material-handling subsystem and/or to place items onto the material-handling subsystem.

12. The method of claim 1, wherein said at least one sensor includes an imaging device.

13. The method of claim 1, wherein the wireless interface is included in the industrial robot.

14. The method of claim 1, which is performed by said remote processor.

15. The method of claim 1, which is performed by a processor that is separate from said remote processor.

16. The method of claim 2, wherein:
the wireless communication link is supported by network infrastructure, and
said monitoring the performance includes obtaining a lower-layer performance indicator from the network infrastructure.

17. The method of claim 2, wherein said monitoring the performance includes carrying out a radio measurement on the wireless communication link.

18. The method of claim 2, wherein said monitoring the performance includes carrying out a measurement on an application layer of the wireless communication link.

19. The method of claim 2, wherein the material-handling subsystem is arranged at least upstream of the industrial robot.
